(19) United States
(12) Patent Application Publication
(10) Pub. No.: US 2025/0206144 A1
(43) Pub. Date: Jun. 26, 2025

(54) COMPUTER SYSTEM AND METHOD FOR ELECTRICALLY PROPELLED VEHCILE

(71) Applicant: VOLVO TRUCK CORPORATION, Göteborg (SE)

(72) Inventors: Niclas JOHNSON, Billdal (SE); Per HASSELBERG, Torslanda (SE); Anders ERIKSSON, Torslanda (SE)

(73) Assignee: VOLVO TRUCK CORPORATION, Göteborg (SE)

(21) Appl. No.: 18/987,662

(22) Filed: Dec. 19, 2024

(30) Foreign Application Priority Data
Dec. 22, 2023 (EP) 23219634.5

(51) Int. Cl. B60L 7/18; B60L 15/20; B60L 58/12

(52) U.S. Cl. CPC B60L 7/18; B60L 15/2018; B60L 58/12

(57) ABSTRACT

Present disclosure relates to a computer system comprising processing circuitry configured to obtain state of charge data from a brake energy storage battery of an electrically propelled vehicle, said vehicle comprising an electrical motor brake system for braking at least one electrical propulsion motor of said vehicle and charging the brake energy storage battery with regenerative energy obtained from the electrical propulsion motor, and cause control of the state of charge of the brake energy storage battery based on road segment data associated with a road segment ahead of the vehicle and the state of charge data.

### TECHNICAL FIELD

The disclosure relates generally to computer systems and computer-implemented methods. In particular aspects, the disclosure relates to computer system and a computer-implemented method for an electrically propelled vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Conventional friction wheel brakes, drum or disc, fade due to heat when used for longer period to control speed downhill in a fully loaded heavy vehicle such as a fully loaded heavy truck. For vehicles equipped with internal combustion engines, engine braking may be used to control speed and assuring that wheel brakes are not continuously engaged. Thus, brake fading may be avoided.

A fully electric truck uses the electric motor with the batteries' resistance to generate brake power going downhill and thus avoiding wheel brakes fading. When an electric truck is fully charged, the batteries does not provide sufficient resistance for the electric motor and therefore brake power from the driveline is substantially reduced. In such case, there is a big risk of wheel brake fading and consequent loss of speed control.

A need for improvement within the field has been identified.

### SUMMARY

According to a first aspect of the disclosure, a computer system is provided. The computer system comprises processing circuitry. The processing circuitry is configured to obtain state of charge data from a brake energy storage battery of an electrically propelled vehicle, said vehicle comprising an electrical motor brake system for braking at least one electrical propulsion motor of said vehicle and charging the brake energy storage battery with regenerative energy obtained from the electrical propulsion motor. The processing circuitry is configured to cause control of a state of charge of the brake energy storage battery based on road segment data associated with a road segment ahead of the vehicle and the state of charge data. The first aspect of the disclosure may seek to improve the safety and efficiency of the vehicle. A technical benefit may include that the brake energy storage battery may be controlled to ensure that motor braking may be performed even for long distances. Another technical benefit is that the risk for fading of the wheel brakes may be reduced.

Optionally in some examples, including in at least one preferred example, the road segment data comprises topography data and/or map data associated with a predicted route and/or a current position of the vehicle. A technical benefit may include that the available capacity of the brake energy storage battery may be controlled to provide sufficient resistance for motor braking for an upcoming road segment.

Optionally in some examples, including in at least one preferred example, the processing circuitry being further configured to obtain weight data associated with a weight of the vehicle, and cause control of the state of charge of the brake energy storage battery based on the weight data. A technical benefit may include that the available capacity of the brake energy storage battery may be controlled more accurately due to the regenerative energy correlating to the current weight of the vehicle and any load carried by the vehicle.

Optionally in some examples, including in at least one preferred example, the processing circuitry being further configured to: determine a target state of charge of the brake energy storage battery based on the road segment data, and cause control of the state of charge of the brake energy storage battery based on the target state of charge. A technical benefit may include that the target state of charge allows for an improved accuracy in the control of the available capacity of the brake energy storage battery.

Optionally in some examples, including in at least one preferred example, wherein the processing circuitry is further configured to determine a regenerative charging level associated with the charging of the brake energy storage battery estimated to be provided by the electrical motor brake system for the road segment ahead of the vehicle, and determine the target state of charge based on the regenerative charging level. A technical benefit may include that the predicted amount of regenerative energy generated is utilized to determine how much available capacity is required in order to accommodate for the motor braking for the upcoming road segment.

Optionally in some examples, including in at least one preferred example, wherein the processing circuitry is configured to process the road segment data to identify a downhill slope and cause control of the state of charge of the brake energy storage battery based on the characteristics of the identified downhill slope. A technical benefit may include that a downhill slope commonly is associated with a need for motor braking, thereby requiring available capacity in the brake energy storage battery.

Optionally in some examples, including in at least one preferred example, the vehicle comprises a propulsion battery configured to power the electric propulsion motor.

Optionally in some examples, including in at least one preferred example, the brake energy storage battery is formed by a battery unit provided separately from the propulsion battery. A technical benefit may include that the separate battery unit may be particularly optimized for faster and more efficiently charging during motor braking and discharging between motor braking operations.

Optionally in some examples, including in at least one preferred example, the processing circuitry is configured to cause the brake energy storage battery to be inoperable in response to the state of charge of the propulsion battery being below a capacity threshold value. A technical benefit may include that the propulsion battery is prioritized in cases where there is available capacity in the propulsion battery during a motor braking operation such that the propulsion battery can be utilized to brake the vehicle as desired.

Optionally in some examples, including in at least one preferred example, the propulsion battery forms the brake energy storage battery. A technical benefit may include that the brake energy storage battery may be defined by means of controlling the software controlling the propulsion battery, making it possible to retrofit existing vehicles with a brake energy storage battery in a simple manner. Another technical benefit may include that the cost-efficiency is improved.

Optionally in some examples, including in at least one preferred example, the processing circuitry is configured to determine, based on the state of charge data, the occurrence of a charging operation wherein the brake energy storage battery is recharged, and responsive to the occurrence of the charging operation, cause control of the charging operation based on the road segment data. A technical benefit may include that during a charging operation, for example at a charge station, the charge provided to the battery may be adjusted based on the route on which the vehicle will travel after the charging operation, improving the efficiency of the charging operation and the vehicle.

Optionally in some examples, including in at least one preferred example, the processing circuitry is configured to obtain braking operational data associated with the operation of the electrical motor brake system for the road segment ahead of the vehicle, and cause control of the state of charge of the brake energy storage battery based on said braking operational data. A technical benefit may include the available capacity of the brake energy storage battery may be more accurately controlled as parameters relating to the operation of the motor braking may be taken into account.

According to a second aspect of the disclosure, an electrically propelled vehicle is provided. The electrically propelled vehicle comprises at least one electrical propulsion motor, an electrical motor brake system for braking the at least one electrical propulsion motor and a computer system of any of the herein described examples. The second aspect of the disclosure may seek to improve the safety and efficiency of the vehicle. A technical benefit may include that the brake energy storage battery may be controlled to ensure that motor braking may be performed even for long distances. Another technical benefit is that the risk for fading of the wheel brakes may be reduced.

According to a third aspect of the disclosure, a battery management system is provided. The battery management control system comprises the computer system according to any of the herein described examples. The battery management control system is configured to be operatively connected to an electrically propelled vehicle. The third aspect of the disclosure may seek to improve the safety and efficiency of the vehicle by means of a management system which may be remote from the vehicle. A technical benefit may include that the brake energy storage battery may be controlled to ensure that motor braking may be performed even for long distances from an external device. Another technical benefit is that the risk for fading of the wheel brakes may be reduced.

According to a fourth aspect of the disclosure, a computer-implemented method is provided. The computer-implemented method comprises obtaining, by a processing circuitry of a computer system, state of charge data from a brake energy storage battery of an electrically propelled vehicle, said vehicle comprising an electrical motor brake system for braking at least one electrical propulsion motor of said vehicle and charging the brake energy storage battery with regenerative energy obtained from the electrical motor brake system. The computer-implemented method further comprises causing, by the processing circuitry control of a state of charge of the brake energy storage battery based on road segment data associated with a road segment ahead of the vehicle and the state of charge data. The fourth aspect of the disclosure may seek to improve the safety and efficiency of the vehicle. A technical benefit may include that the brake energy storage battery may be controlled to ensure that motor braking may be performed even for long distances. Another technical benefit is that the risk for fading of the wheel brakes may be reduced.

Optionally in some examples, including in at least one preferred example, the method further comprises obtaining, by the processing circuitry, weight data associated with a weight of the vehicle, and causing, by the processing circuitry, control of the state of charge of the brake energy storage battery based on the weight data. A technical benefit may include that the available capacity of the brake energy storage battery may be controlled more accurately due to the regenerative energy correlating to the current weight of the vehicle and any load carried by the vehicle.

Optionally in some examples, including in at least one preferred example, the method further comprises determining, by the processing circuitry, a target state of charge of the brake energy storage battery based on the road segment data, and causing, by the processing circuitry, control of the state of charge of the brake energy storage battery based on the target state of charge. A technical benefit may include that the target state of charge allows for an improved accuracy in the control of the available capacity of the brake energy storage battery.

Optionally in some examples, including in at least one preferred example, the method comprises determining, by the processing circuitry, a regenerative charging level associated with the charging of the brake energy storage battery estimated to be provided by the electrical motor brake system for the road segment ahead of vehicle, and determining, by the processing circuitry, the target state of charge based on the regenerative charging level. A technical benefit may include that the predicted amount of regenerative energy generated is utilized to determine how much available capacity is required in order to provide sufficient resistance for motor braking for the upcoming road segment.

Optionally in some examples, including in at least one preferred example, the method further comprises processing, by the processing circuitry, the road segment data to identify a downhill slope, and causing control of the state of charge of the brake energy storage battery based on the characteristics of the identified downhill slope. A technical benefit may include that a downhill slope commonly is associated with a need for motor braking, thereby requiring available capacity in the brake energy battery storage.

Optionally in some examples, including in at least one preferred example, the brake energy storage battery is a dedicated battery provided separately from a propulsion battery configured to power the electric propulsion motor of the vehicle. The method further comprises causing, by the processing circuitry, the brake energy storage battery to be inoperable in response to the state of charge of the propulsion battery being below a capacity threshold value. A technical benefit may include that the separate battery unit may be particularly optimized for faster and more efficiently charging during motor braking and discharging between motor braking operations. Another technical benefit may include that the propulsion battery is prioritized in cases where there is available capacity in the propulsion battery during a motor braking operation such that the propulsion battery can be utilized to brake the vehicle as desired.

Optionally in some examples, including in at least one preferred example, the method further comprises determining, by the processing circuitry, the occurrence of a charging operation wherein the brake energy storage battery is recharged, and responsive to the occurrence of the charging operation, causing, by the processing circuitry, control of the charging operation based on the road segment data. A technical benefit may include that during a charging operation, for example at a charge station, the charge provided to the battery may be adjusted based on the route on which the vehicle will travel after the charging operation, making the charging operation and the vehicle more efficient.

Optionally in some examples, including in at least one preferred example, the method further comprises obtaining, by the processing circuitry, braking operational data associated with the operation of the electrical motor brake system for the road segment ahead of the vehicle, and causing, by the processing circuitry of the state of charge of the brake energy storage battery based on said braking operational data. A technical benefit may include the available capacity of the brake energy storage battery may be more accurately controlled as parameters relating to the operation of the motor braking may be taken into account.

According to a fifth aspect of the disclosure, a computer program product is provided. The computer program product comprises program code for performing, when executed by a processing circuitry, the method of any of the examples described herein. The fifth aspect of the disclosure may seek to improve the safety and efficiency of the vehicle. A technical benefit may include that the brake energy storage battery may be controlled to ensure that motor braking may be performed even for long distances. Another technical benefit is that the risk for fading of the wheel brakes may be reduced.

According to a sixth aspect of the disclosure, a non-transitory computer-readable storage medium is provided. The non-transitory computer-readable storage medium comprises instructions, which when executed by a processing circuitry, cause the processing circuitry to perform the method of any of the examples described herein. The sixth aspect of the disclosure may seek to improve the safety and efficiency of the vehicle. A technical benefit may include that the brake energy storage battery may be controlled to ensure that motor braking may be performed even for long distances. Another technical benefit is that the risk for fading of the wheel brakes may be reduced.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary side view of a vehicle according to an example.

FIG. 2 is a schematic view of a vehicle according to an example.

FIG. 3 is a schematic view of a vehicle according to another example.

FIG. 4 is an exemplary block diagram of a computer system and vehicle according to an example.

FIG. 5 is an exemplary block diagram of a computer system and vehicle according to another example.

FIG. 6 is an exemplary block diagram of a brake battery manager according to an example.

FIG. 7 is a schematic drawing of an exemplary implementation of the brake battery manager of FIG. 6.

FIG. 8 is an exemplary block diagram of a method according to an example.

FIG. 9 is an exemplary block diagram of a method according to another example

FIG. 10 is an exemplary block diagram of a method according to another example.

FIG. 11 is an exemplary block diagram of a computer program product according to an example.

FIG. 12 is a schematic diagram of an exemplary computer system for implementing examples disclosed herein, according to an example.

FIG. 13 is another view of FIG. 1 according to an example.

### DETAILED DESCRIPTION

The detailed description set forth below provides information and examples of the disclosed technology with sufficient detail to enable those skilled in the art to practice the disclosure.

The present disclosure provides a method and system which may address the risk of the batteries of an electrically propelled vehicle not providing enough resistance to enable braking of the vehicle by means of motor braking.

FIG. 1 is an exemplary schematic side view of a heavy-duty vehicle 10 (hereinafter referred to as vehicle 10). The vehicle 10 comprises a tractor unit 10a which is arranged to tow a trailer unit 10b. In other examples, other vehicles may be employed, e.g., trucks, buses, and construction equipment. The vehicle 10 comprises all vehicle units and associated functionality to operate as expected, such as a drivetrain 18, chassis, and various control systems. The vehicle 10 comprises one or more propulsion sources 12. The vehicle 10 is an electrically propelled vehicle. Thus, the one or more propulsion source 12 may comprise at least one electrical propulsion motor. It may be envisioned that the one or more propulsion source 12 may additionally comprise any suitable propulsion source 12 exemplified by, but not limited to, one or more or a combination of an electrical motor, a combustion engine such as a diesel, gas or gasoline powered engine. The one or more propulsion source 12, e.g. the at least one electrical propulsion motor 12, is configured to transfer (mechanical) power to the drivetrain 18. The drivetrain 18 is configured to transfer power from the propulsion source 12 to one or more wheels 15 of the vehicle 10. The drive train may comprise one or more transmissions, drive shafts, axles, differentials etc. The vehicle 10 further comprises an energy source suitable for providing energy for the at least one electrical propulsion motor 12. Since the propulsion source is an electrical propulsion motor 12, a suitable energy source would be a battery.

The at least one electrical propulsion motor 12 may be utilized for braking the vehicle 10. The vehicle 10 may thus comprise an electrical motor brake system 19 for braking the at least one electrical propulsion motor 12 of the vehicle 10 and charging a brake energy storage battery 16 with regenerative energy obtained from the electrical motor brake system 19. The vehicle 10 may thus comprise the brake energy storage battery 16.

The electrical motor brake system 19 may be configured to cause regenerative braking of the electrical propulsion motor 12. The electrical motor brake system 19 may be configured to distribute the regenerative energy provided by the regenerative braking of the electrical propulsion motor 12 to the brake energy storage battery 16 and/or the propulsion battery 14. The regenerative energy may thus charge the brake energy storage battery 16 and/or the propulsion battery 14. The electrical motor brake system 19 may be configured to cause the electrical propulsion motor 12 to act as a generator to enable motor braking and providing the regenerative energy. The electrical motor brake system 19 may thus comprise circuitry configured to cause switching of the current provided to the electrical propulsion motor 12 and electrically connecting the electrical propulsion motor 12 to the brake energy storage battery 14 and/or the propulsion battery 16.

The brake energy storage battery 16 may form a part of a propulsion battery 14 of the vehicle 1 or be provided as a separate battery. The propulsion battery 14 may be configured to power the electric propulsion motor 12.

The vehicle 10 further comprises sensor circuitry 11 arranged to detect, measure, sense or otherwise obtain data relevant for operation of the vehicle 10. The sensor circuitry 11 may comprise one or more of an accelerometer, a gyroscope, a wheel Speed Sensor, an ABS sensor, a throttle position sensor, a fuel level sensor, a temperature Sensor, a pressure sensor, a rain sensor, a light sensor, proximity sensor, a lane departure warning sensor, a blind spot detection sensor, a TPMS sensor, a current sensor, a rpm sensor etc. Operational data relevant for operation of the vehicle 10 may include, but is not limited to, one or more of a speed of the vehicle 10, a weight of the vehicle 10, an inclination of the vehicle 10, a status of an energy source of the vehicle 10 (state of charge, fuel level etc.), a current speed limit of a current road travelled by the vehicle 10, etc.

Accordingly, the sensor circuitry 11 may be configured to detect, measure, sense or otherwise obtain state of charge data associated with the state of charge of the brake energy battery 16 and/or the propulsion battery 14.

The vehicle 10 further comprises communications circuitry 40 configured to receive and/or send communication.

A computer system 700 may be provided. The computer system 700 may be operatively connected to, the drivetrain 18, the sensor circuitry 11, the electrical motor brake system 19, the brake energy storage battery 16, the propulsion battery 14, the communications circuitry 40 and/or the at least one electrical propulsion motor 12 of the vehicle 10. The computer system 700 comprises processing circuitry 702. The computer system 700 may comprise a storage device 720, advantageously a non-volatile storage device such as a hard disk drives (HDDs), solid-state drives (SSDs) etc. In some examples, the storage device 720 is operatively connected to the computer system 700.

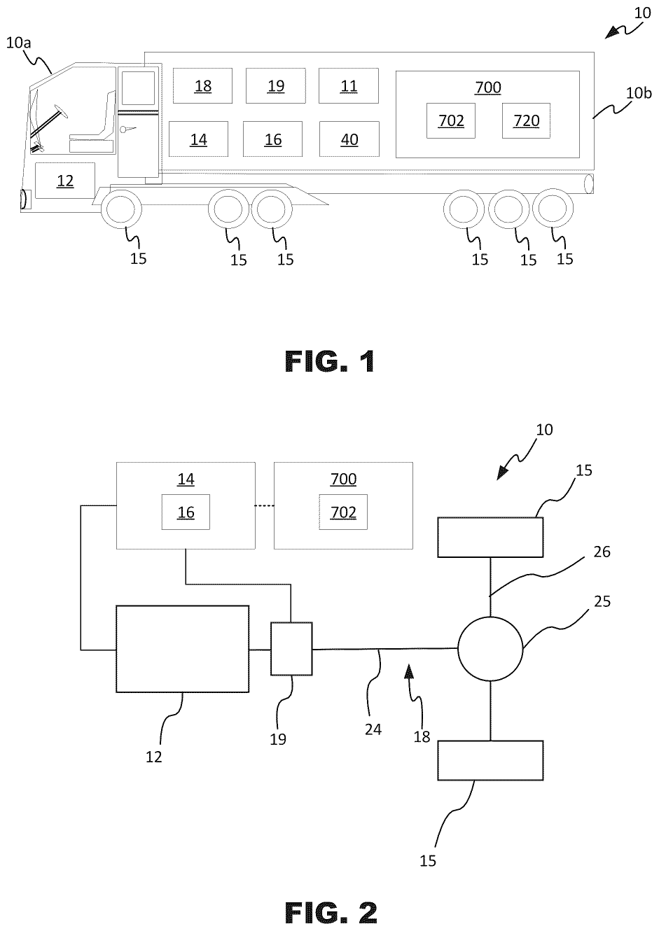

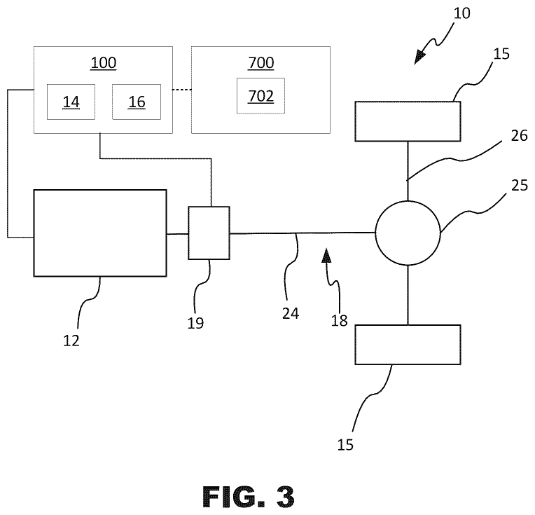

FIG. 2-3 depicts examples of a vehicle 10 and a computer system 700.

The vehicle 10 may comprise the drivetrain 18. The electrical propulsion motor 12 may be able to drive the drive wheels 15 of the vehicle 10 via the drivetrain 18. In the depicted example, the drivetrain 18 comprises a propeller shaft 24, a differential 25 and/or a drive shaft 26 for each drive wheel 15. In the depicted example, the vehicle does not include a gearbox or clutch, however it may be envisioned that the drivetrain 18 may comprise a gearbox and/or a clutch. It may also be envisioned that additional propulsion sources are utilized. Accordingly, the vehicle may very well comprise additional electrical propulsion motors and/or combustion engine(s) connected to the drivetrain 18 for driving the drive wheels 15.

In FIG. 2, the propulsion battery 14 forms the brake energy storage battery 16. Hence, the functionality of the brake energy storage battery 16 may be provided by the propulsion battery 14. The electrical motor brake system 19 may thus be configured to charge the propulsion battery 14 with the regenerative energy obtained from the electrical propulsion motor 12.

The brake energy storage battery 16 may be defined relative the propulsion battery 14 in a plurality of ways.

In one example, the brake energy storage battery 16 may be formed by the propulsion battery 14 as a whole. According to such an example, the capacity of the brake energy storage battery 16 is equivalent to the capacity of the propulsion battery 14.

In one example, the brake energy storage battery 16 may be defined by a physical partition of the propulsion battery 14. For example, the brake energy storage battery 16 may be provided as one or more of a plurality of modules and/or battery cells forming the propulsion battery 16. The capacity of the brake energy storage battery 16 may thus be equivalent to the capacity of the physical partition of the propulsion battery 14. The capacity of said physical partition may be independently controlled relative the remaining propulsion battery 14 by means of a battery control system and/or the computer system 700.

In one example, the brake energy storage battery 16 may be defined by a virtual partition of the propulsion battery 14. For example the brake energy storage battery 14 may be virtually defined by means of the battery control system and/or the computer system 700. The capacity of the brake energy storage battery 16 may thus be equivalent to a determined state of charge dedicated to provide the brake energy storage battery 16.

Further referencing FIG. 2, the brake energy system 19 may be configured to charge the propulsion battery 14 with the regenerative energy obtained from the electrical propulsion motor 12 thereby charging the propulsion battery 14 and/or the brake energy storage battery 16.

As aforementioned, the propulsion battery 14 may be configured to power the electrical propulsion motor 12. The brake energy storage battery 16 may also be configured to power the electrical propulsion motor 12. The electrical motor brake system 19, the propulsion battery 14 and the brake energy storage battery 16 may be electrically connected to the electrical propulsion motor 12. The electrical motor brake system 19, the propulsion battery 14, the brake energy storage battery 16 and/or the electrical propulsion motor 12 may be operatively connected to the computer system 700.

It may be envisioned that the brake energy storage battery 16 and/or the propulsion battery 14 may be electrically connected to other components of the vehicle 10 and configured to power said components.

FIG. 3 depicts a vehicle 10 and a computer system 700 according to another example.

In the depicted example, the brake energy storage battery 16 is formed by a battery unit provided separately from the propulsion battery 14. Hence, the brake energy storage battery 16 may provided as a separate battery unit independent from the propulsion battery 14. In one example, the vehicle 10 may comprise a battery system 100, the battery system 100 may comprise the brake energy storage battery 16 and the propulsion battery 14.

The brake energy storage battery 16 may be configured to power the electric propulsion motor 12 and/or any other component of the vehicle 10. Hence, in contrast to the propulsion battery 14, the brake energy storage battery 16 may not necessarily be configured to power the electrical propulsion motor 12.

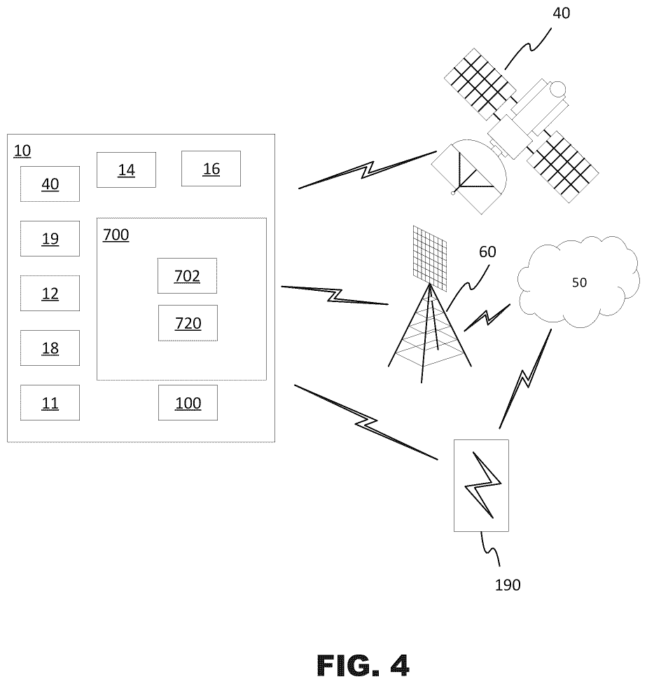

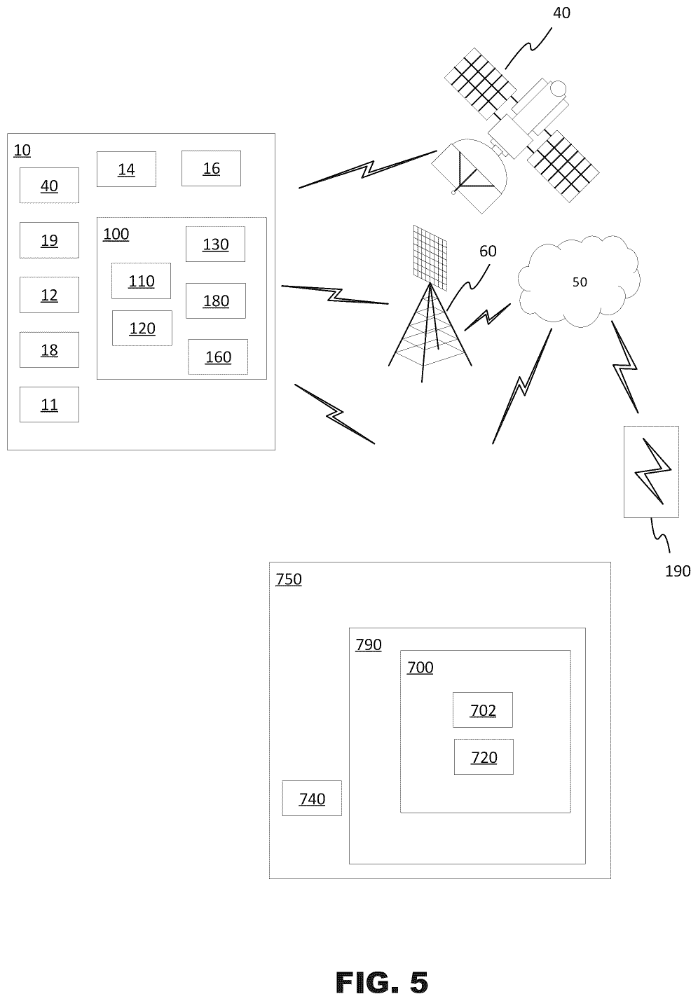

FIG. 4-5 depicts block views of the vehicle 10 and the computer system 700. The computer system 700 may be partially or entirely comprised in the vehicle 10. The computer system 700 may also be provided in entirety externally from the vehicle 10.

The vehicle 10 may be in operative communication with external devices, such as a charging station 190 and, in case of the computer system 700 being fully or partially external to the vehicle 10, the computer system 700. The connection may be provided by e.g. the communications circuitry 40. The vehicle 10 may be in communication with the external devices directly or via a cloud (backend) server 50. The vehicle 10 may communicate with the cloud server 50 directly or via a communications interface such as a cellular communications interface 60, such as a radio base station. The cloud server 50 may be any suitable cloud server exemplified by, but not limited to, Amazon Web Services (AWS), Microsoft Azure, Google Cloud Platform (GCP), IBM Cloud, Oracle Cloud Infrastructure (OCI), DigitalOcean, Vultr, Linode, Alibaba Cloud, Rackspace etc. The communications interface may be a wireless communications interface exemplified by, but not limited to, Wi-Fi, Bluetooth, Zigbee, Z-Wave, LoRa, Sigfox, 2G (GSM, CDMA), 3G (UMTS, CDMA2000), 4G (LTE), 5G (NR) etc. Communication with the external devices may be provided by any suitable communications protocol exemplified by, but not limited to Dedicated Short-Range Communications (DSRC), Cellular Vehicle-to-Everything (C-V2X), IEEE 802.11p, LTE-V (LTE-V2X), 5G NR (New Radio) V2X, etc. The vehicle 10 may further be operatively connected to a Global Navigation Satellite System (GNSS) 40 exemplified by, but not limited to, global positioning system (GPS), Globalnaya Navigatsionnaya Sputnikovaya Sistema (GLONASS), Galileo, BeiDou Navigation Satellite System, Navigation with Indian Constellation (NavIC) etc. The vehicle 10 may be configured to utilize data obtain from the GNSS 40 to determine a geographical position of the vehicle 10.

The vehicle 10 may comprise some or all parts of the computer system 700 and/or the cloud server 50 may comprise some or all part of the computer system 700 and/or an external device may comprise some or all part of the computer system 700. The computer system 700 may be operatively connected to the communications circuitry 40, the sensor circuitry 11, the propulsion battery 14, the brake energy storage battery 16 and/or the electrical propulsion motor 12 of the vehicle 10. The computer system 700 comprises processing circuitry 702. The computer system 700 may comprise the storage device 720, advantageously a non-volatile storage device such as a hard disk drives (HDDs), solid-state drives (SSDs) etc. In some examples, the storage device 720 is operatively connected to the computer system 700.

The computer system 700 and associated functionality and features will be discussed in some further detail. The computer system 700 may be configured to obtain road segment data associated with a road segment ahead of the vehicle 10. The road segment data may comprise topography data and/or map data associated with a predicted route and/or a current position of the vehicle 10.

The road segment data may be associated with an identifier of an upcoming road segment. The road segment data may be obtained from an electronic device. The electronic device may be the cloud server 50 or a local storage of the vehicle 10, such as the previously presented storage device 720 of the computer system 700. The road segment data may be any suitable information concerning physical features and characteristics of the Earth's surface. The road segment data may comprise details such as, but not limited to, elevation, slope, terrain, landforms, and/or other spatial attributes. The road segment data may be exemplified by, but not limited to, Digital Elevation Models (DEMs), contour lines, slope and aspect maps etc. The road segment data may be produced by e.g. government agencies, research institutions, and/or commercial providers.

In the example depicted in FIG. 4, the computer system 700 is at least partially provided as a part of the vehicle 10. In particular, the computer system 700 is depicted as being fully comprised in the vehicle 10.

The computer system 700 may thus at least partially be comprised a the vehicle control system 100. The vehicle control system 100 may be operatively connected to the communications circuitry 40, the propulsion battery 14, the brake energy storage battery 16, the electrical motor brake system 12, the drivetrain 18 and/or the sensor circuitry 11. The vehicle control system 100 may be configured to control and/or obtain data from said communications circuitry 40, the propulsion battery 14, the brake energy storage battery 16, the electrical motor brake system 12, the drivetrain 18 and/or the sensor circuitry 11.

In the example depicted in FIG. 5, the computer system 700 is at least partially provided as a part of an external device. In particular, the computer system 700 is depicted as being fully comprised in an external device, herein referenced as a remote device 750. The remote device 750 may be a computing device such as a mobile phone, tablet, computer, laptop etc.

As depicted in FIG. 5, the vehicle control system 100 comprises processing circuitry 110. The vehicle control system 100 may comprise a storage device 120, advantageously a non-volatile storage device such as a hard disk drives (HDDs), solid-state drives (SSDs) etc. In some examples, the storage device 120 is operatively connected to the computer system 100.

The remote device 750 may be in operative communication with the vehicle 10 and/or external devices, such as the charging station 190 and, in case of the computer system 700 being fully or partially external to the external device 10, the computer system 700. The connection may be provided by e.g. the communications circuitry 740 of the remote device 750. The remote device 750 may be in communication with the vehicle 10, e.g. the communications circuitry 40 of the vehicle 10, directly or via the cloud (backend) server 50. The remote device 750 may communicate with the cloud server 50 directly or via the communications interface such as the cellular communications interface 60, such as a radio base station. The cloud server 50 may be any suitable cloud server exemplified by, but not limited to, Amazon Web Services (AWS), Microsoft Azure, Google Cloud Platform (GCP), IBM Cloud, Oracle Cloud Infrastructure (OCI), DigitalOcean, Vultr, Linode, Alibaba Cloud, Rackspace etc. The communications interface may be a wireless communications interface exemplified by, but not limited to, Wi-Fi, Bluetooth, Zigbee, Z-Wave, LoRa, Sigfox, 2G (GSM, CDMA), 3G (UMTS, CDMA2000), 4G (LTE), 5G (NR) etc. Communication with the external devices may be provided by any suitable communications protocol exemplified by, but not limited to Dedicated Short-Range Communications (DSRC), Cellular Vehicle-to-Everything (C-V2X), IEEE 802.11p, LTE-V (LTE-V2X), 5G NR (New Radio) V2X, etc. The remote device 750 may further be operatively connected to a Global Navigation Satellite System (GNSS) 40 exemplified by, but not limited to, global positioning system (GPS), Globalnaya Navigatsionnaya Sputnikovaya Sistema (GLONASS), Galileo, BeiDou Navigation Satellite System, Navigation with Indian Constellation (NavIC) etc. The remote device 750 may be configured to utilize data obtain from the GNSS 40 to determine a geographical position of the vehicle 10 and/or the remote device 750.

The remote device 750 may comprise some or all parts of the computer system 700 and/or the cloud server 50 may comprise some or all part of the computer system 700 and/or an external device may comprise some or all part of the computer system 700. The computer system 700 may be operatively connected to the communications circuitry 740 of the remote device 750, the sensor circuitry 11, the energy source 14 and/or the electrical propulsion motor 12 of the vehicle 10. To enable communication with the vehicle control system 100, the communications circuitry 740 of the remote device 750 may be configured to be in operative communication with the communications circuitry 40 of the vehicle 10.

As aforementioned, the computer system 700 may be configured to obtain road segment data associated with a road segment ahead of the vehicle 10. The road segment data may be obtained from an electronic device. The electronic device may be the cloud server 50, a local storage of the vehicle 10, such as the storage device 120 of the vehicle control system 100 or a local storage of the remote device 750 such as the previously presented storage device 720 of the remote device 750.

A battery management control system 790 may provided. The battery management control system 790 may be configured to be operatively connected to the vehicle 10. The remote device 750 may partly or fully comprise the battery management control system 790. The battery management control system 790 may comprise the computer system 700.

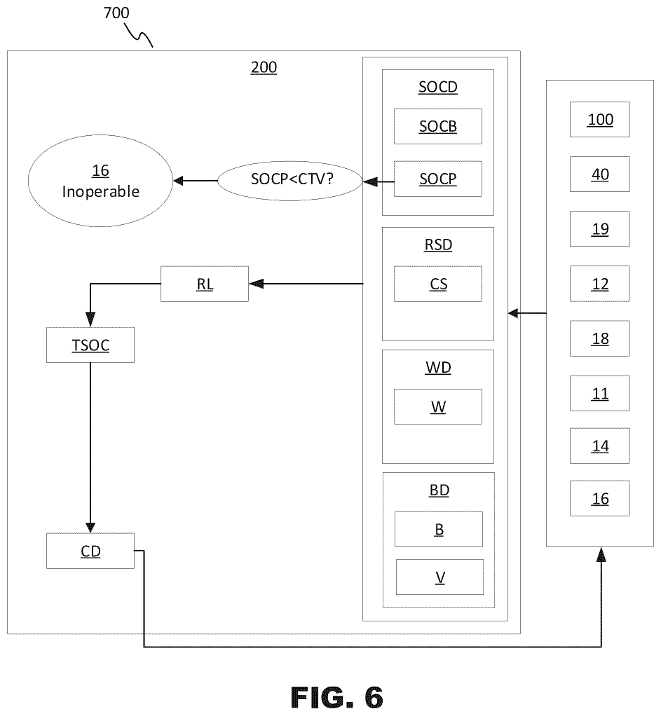

In FIG. 6, a block diagram of a brake energy battery manager 200 is shown. The brake energy battery manager 200 may form part of the computer system 700 previously introduced, and the functionalities of the brake energy battery manager 200 may be provided by the processing circuitry 702 of the computer system 700. It should be mentioned that the brake energy manager 200 of FIG. 6 is a specific example and the detailed examples provided in the following are optional implementation examples.

The brake energy battery manager 200 is operatively connected to the brake energy storage battery 16. The brake energy battery manager 200 may be operatively connected to the vehicle control system 100, the communications circuitry 40, the electrical motor brake system 19, the electrical propulsion motor 12, the drivetrain 18 and/or the sensor circuitry 11.

The processing circuitry 702 of the computer system 700, e.g. via the brake energy battery manager 200, may be configured to obtain state of charge data SOCD from the brake energy storage battery 16. The processing circuitry 702, e.g. via the brake energy battery manager 200, may be configured to cause control of the state of charge SOCB of the brake energy storage battery 16 based on the road segment data RSD and the state of charge data SOCD.

Notably, the functionality described in the following with reference to brake energy battery manager 200 may be performed by means of the computer system 700 and as said computer system 700 comprises said brake energy battery manager 200. The functionality may be called upon by the processing circuitry 702.

Hence, the brake energy battery manager 200 may be configured to obtain the state of charge data SOCD and cause control of the state of charge SOCB of the brake energy storage battery 16.

In one example, the state of charge data SOCD may be provided by the sensor circuitry 11. The sensor circuitry 11 may be configured to monitor the state of charge of the brake energy storage battery 16. The sensor circuitry 11 may be configured to retrieve the state of charge data SOCD from the brake energy storage battery 16. The brake energy battery manager 200 may be configured to obtain state of charge data SOCD from the brake energy storage battery 16 via the sensor circuitry 11.

In one example, the brake energy battery manager 200 may be configured to obtain state of charge data from the propulsion battery 14. In one example, the sensor circuitry 11 may be configured to monitor the state of charge of the propulsion battery 14. The sensor circuitry 11 may be configured to retrieve the state of charge data SOCD from the propulsion battery 14. The brake energy battery manager 200 may be configured to obtain state of charge data from the propulsion battery 14 via the sensor circuitry 11. In the depicted example, the propulsion battery 16 may have a state of charge SOCP.

In one example, the brake energy battery manager 200 may be configured to provide control data CD for causing the control of the state of charge of the brake energy storage battery 16. Based on the control data CD, the vehicle control system 100 may be configured to cause control of the state of charge of the brake energy storage battery 16. In one example, the control data CD may be retrieved by a battery control system of the vehicle control system 100. The control system 100 may be configured to control the brake energy storage battery 16 and/or the propulsion battery 14.

In one example, the brake energy battery manager 200 may be configured to obtain weight data WD associated with a weight of the vehicle 10. The brake energy battery manager 200 may be configured to cause control of the state charge SOCB of the brake energy storage battery 16 based on the weight data WD. The weight data WD may be provided by the sensor circuitry 11. The sensor circuitry 11 may be configured to monitor the weight of the vehicle 10. The brake energy battery manager 200 may be configured to obtain the weight data WD from the sensor circuitry 11.

In one example, the brake energy battery manager 200 is configured to determine a target state of charge TSOC of the brake energy storage battery 16 based on the road segment data RSD. In one example, the target state of charge TSOC may be associated with a target state of charge of the brake energy storage battery 16 at the end of the road segment ahead of the vehicle 10.

The brake energy battery manager 200 may be configured to cause control of the state of charge SOCB of the brake energy storage battery 16 based on the target state of charge TSOC.

In one example, the brake energy battery manager 200 may be configured to determine a regenerative charging level RL. The regenerative charging level RL may be associated with the charging of the brake energy storage battery 16 estimated to be provided by the electrical motor brake system 19 for the road segment ahead of the vehicle 10. The brake energy battery manager 200 may be configured to determine the target state of charge TSOC based on the regenerative charging level RL.

In one example, the brake energy battery manager 200 may be configured to process the road segment data RSD to identify a downhill slope. The brake energy battery manager 200 may be configured to control of the state of charge SOCB of the brake energy storage battery 16 based on the characteristics CS of the identified downhill slope. In one example, the processing circuitry 702, i.e. the brake energy battery manager 200, may be further configured to process the road segment data RSD to determine the presence of the downhill slope and responsive to determining the presence of the downhill slope, control the state of charge SOCB of the brake energy storage battery 16 based on the characteristics of the downhill slope.

In one example, the brake energy battery manager 200 may be configured to determine based on the state of charge data SOCD the occurrence of a charging operation wherein the brake energy storage battery 16 is recharged. The brake energy battery manager 200 may responsive to the occurrence of the charging operation, cause control of the charging operation based on the road segment data RSD. The charging operation may be performed at the charging station 190. The brake energy battery manager 200 may thus be configured to determine, based on the state of charge data SOCD, the occurrence of a charging operation at the charging station 190 wherein the brake energy storage battery 16 is recharged. Responsive to the occurrence of the charging operation, the brake energy battery manager 200 may be configured to cause control of the charging operation based on the road segment data RSD. The brake energy battery manager 200 may thus be configured to control the charging performed at the charging station 190, e.g. via an external power source of the charging station 190, based on the state of charge data SOCD and the road segment data RSD. The brake energy battery manager 200 may be configured to control the charging operation by means of controlling the charging station 190 and/or the electrically propelled vehicle 10.

In the use case of the brake energy storage battery 16 being provided as a separate battery from the propulsion battery 14, the brake energy battery manager 200 may only enable use of the brake energy storage battery 16 in cases where the propulsion battery 14 is at full or high capacity. The brake energy battery manager 200 may thus be configured to cause the brake energy storage battery 16 to be inoperable in response to the state of charge SOCP of the propulsion battery 16 being below a capacity threshold value CTV.

In one example, the processing circuitry 702 may be configured to obtain braking operational data BD associated with the operation of the electrical motor brake system 19 for the road segment ahead of the vehicle 10 and cause control of the state of charge SOCB of the brake energy storage battery 16 based on the braking operational data BD. The brake energy battery manager 200 may be configured to obtain the braking operational data BD and cause control of the state of charge SOCB of the brake energy storage battery 16 based on the braking operational data BD.

The braking operational data BD may be obtained from the vehicle control system 100. In one example, the braking operational data BD may be obtained from a cruise control function of the vehicle control system 100. The cruise control function may comprise a predictive cruise control. The predictive cruise control may utilize the road segment data RSD. The braking operational data BD may comprise vehicle speed data V associated with the predicted speed of the vehicle 10 for the road segment and/or motor brake activation data B associated with activation of the electrical motor brake system 19 for the road segment. The motor brake activation data B may comprise data associated with the extent and/or timing of the activation of the electrical motor brake system 19 for the road segment.

In one example, the regenerative charging level RL may be determined based on the braking operational data BD, the weight data WD, the road segment data RD and/or the state of charge data SOCD.

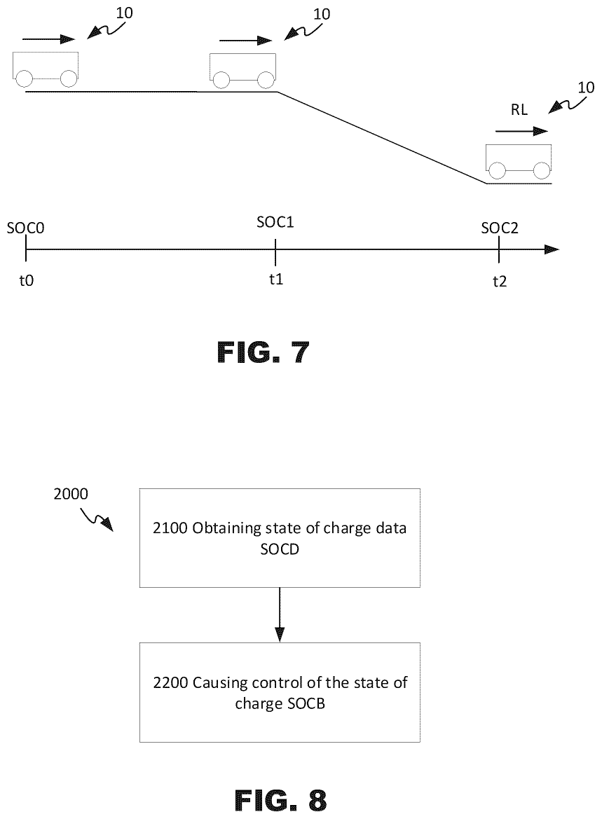

FIG. 7 depicts an exemplary implementation of the brake energy battery manager 200 and the computer system 700. The vehicle 10 at the time t0 is positioned at a position prior to the start of a downhill slope of the route ahead of said vehicle 10. At the time t1, the vehicle 10 is positioned at the start of the downhill slope. At the time t2, the vehicle 10 is positioned at the end of the downhill slope.

At the time t0, the brake energy battery manager 200 may determine from the road segment data RSD the occurrence of the downhill slope. The brake energy battery manager 200 may process the road segment data RSD to determine the characteristics CS of the downhill slope. Such characteristics may include the length and incline/decline of the downhill slope. Based on the characteristics CS and potentially the weight of the vehicle 10 and/or the braking operational data BD, the brake energy battery manager 200 may determine the regenerative charging level RL. The regenerative charging level RL is associated with the charging of the brake energy storage battery 16 estimated to be provided by the electrical motor brake system 19 for the downhill slope. The regenerative charging level RL thus provides an indication of how much regenerative braking energy will be generated during the braking of the electrical propulsion motor 12 of the vehicle 10 during the downhill slope.

At the time t0, the state of charge of the brake energy storage battery 14 may herein be referenced at SOC0. The brake energy battery manager 200 may determine the state of charge SOC0 based on the state of charge data SOCD. The target state of charge TSOC may be associated with a target state of charge of brake energy storage battery 16 at the end of the downhill slope. The regenerative charging level RL may in this case be associated with a correlated state of charge SOC2 of the brake energy storage battery 16 at the time t2 after the downhill slope. Based on the determined state of charge SOC0 before the downhill slope and the determined state of charge SOC2 after the downhill slope, a target state of charge TSOC of the brake energy storage battery 16 may be determined by the brake energy battery manager 200. The target state of charge TSOC may be determined such that enough available capacity is provided in the brake energy storage battery 16 to accommodate the amount of regenerative braking energy indicated by the determined regenerative charging level RL. The brake energy battery manager 200 may then control the state of charge SOC of the brake energy storage battery 16 in accordance with the target state of charge TSOC.

Depending on the nature of the operation of the vehicle 10 at the time t0, the control based on the target state of charge TSOC may vary.

In one example, the vehicle 10 may at the time t0 be parked at a charging station 190 (as described with reference to FIG. 4-5). At the charging station, the brake energy storage battery 16 may be charged. The brake energy battery manager 200 may thus determine the occurrence of a charging operation. The brake energy battery manager 200 may cause control of the charging operation based on the determined target state of charge TSOC. For example, a maximum level of state of charge provided by the charging operation may be set, ensuring that the brake energy storage battery 16 has enough capacity to accommodate the regenerative energy determined to be generated during the braking of the electrical propulsion motor 12 in the upcoming downhill slope. Accordingly, the brake energy battery manager 200 may cause the amount of charge provided to the brake energy storage battery 16 in the charging operation to be limited in accordance with target state of charge TSOC.

In one example, the vehicle 10 may at the time t0 be moving. If the downhill slope is detected while the vehicle 10 is moving, it may be determined that the state of charge SOC0 at the time t0 is too high in order to accommodate the regenerative energy indicated by the determined regenerative energy level RL. Hence, it may be of importance that the state of charge of the brake energy storage battery 16 is reduced before the time t1 when the vehicle 10 reaches the downhill slope. Thus, in the event of the state of charge SOC0 at the time t0 exceeds an initial target state of charge at the time t1 based on the determined target state of charge TSOC, the brake energy battery manager 200 may cause discharging of the brake energy storage battery 16 such that the target state of charge TSOC may be obtained at the time t2. Depending on the implementation of the brake energy storage battery 16 this may be performed by means of causing the brake energy storage battery 16 to power the electrical propulsion motor 12 and/or auxiliary components of the vehicle 10.

The brake energy battery manager 200 may cause the discharging of the brake energy storage battery 16 based on the determined target state of charge TSOC. The brake energy battery manager 200 may cause a discharge such that the state of charge of the brake energy storage battery 16 is within an acceptable interval relative to the target state of charge TSOC. In the depicted example, the brake energy battery manager 200 may cause the discharge such that the state of charge SOC1 at the time t1 is within the acceptable interval relative to the target state of charge TSOC. Thus, it is ensured at the point where the vehicle 10 starts to travel through the downhill slope that there is enough capacity in the brake energy storage battery 16 for the braking of the electrical propulsion motor 12 during the downhill slope until the time t2, e.g. the end of the downhill slope.

FIG. 8 depicts a method 2000 according to an example. In one example, the method 2000 may be performed by the computer system 700. The method 2000 may be expanded to include any of the features, examples and effects presented herein. The method 2000 may comprise obtaining 2100, by the processing circuitry 702, the state of charge data SOCD and causing 2200, by the processing circuitry 702, control of the state of charge SOCB.

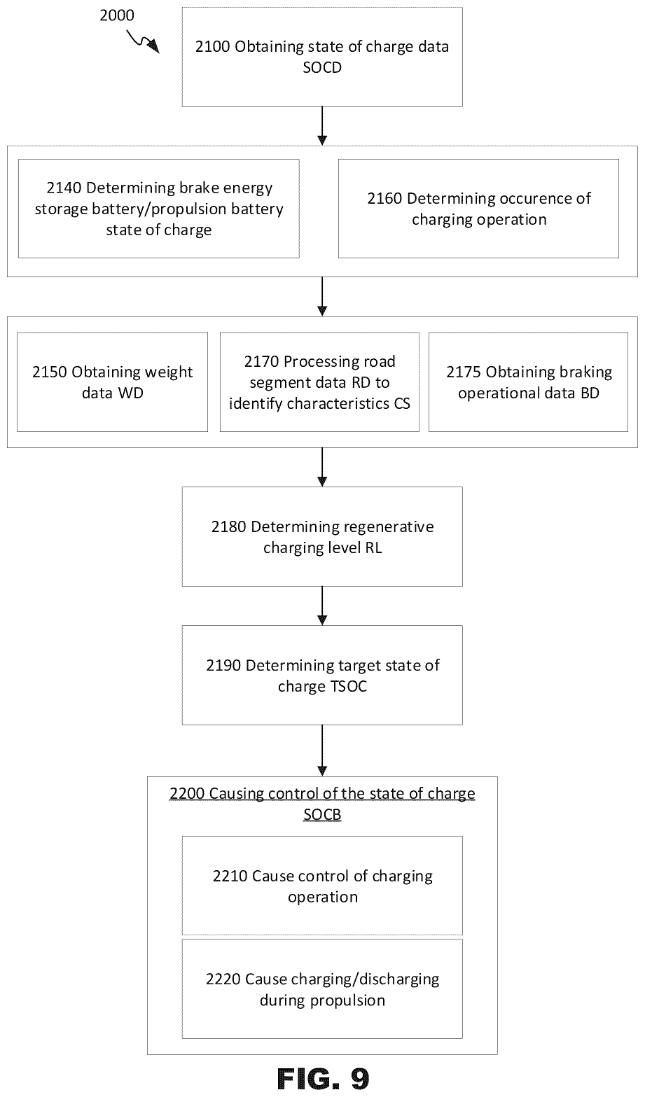

FIG. 9 depicts a method according to an example. The method 2000 herein described may be performed by the processing circuitry 702 of the computer system 700.

The state of charge data SOCD is obtained 2100. Based on the state of charge data SOCD, parameters related to the brake energy storage battery 16 and/or the propulsion battery 14 may be determined. In one example, the state of charge of the brake energy storage battery 16 and/or the propulsion battery 14 is determined 2140.

In one example, the state of charge data SOCD may be utilized to determining the occurrence of the charging operation. The occurrence of the charging operation may be determined 2160 based on the state of charge data SOCD.

The method may further comprise obtaining 2150 the weight data WD. Based on the weight data WD the weight of the vehicle 10 may be determined. Optionally, the weight data WD may comprise the actual weight of vehicle 10.

In one example, the method may further comprise processing 2170 the road segment data 2170 to identify the characteristics CS of the road segment ahead of the vehicle 10.

In one example, the method may comprise obtaining 2175 braking operational data BD associated with the operation of the electrical motor brake system 19 for the road segment ahead of the vehicle 10.

Based on the state of charge SOCB of the brake energy storage battery 16, the state of charge SOCP of the propulsion battery 14, the weight data WD, the road segment data RD, the braking operational data BD and/or the characteristics CS of the road segment ahead of the vehicle 10, the regenerative charging level RL may be determined 2180.

Based on the regenerative charging level RL, the target state of charge SOCB of the brake energy battery storage battery 16 may be determined 2190. The target state of charge SOCB may be utilized for the control of the brake energy storage battery 16. The method may thus comprise causing 2200 causing control of the state of charge SOCB of the brake energy storage battery 16 based on the target state of charge TSOC.

The control of the brake energy storage 16 may in one example comprise causing 2210 control of a charging operation. The charging operation may be a charging operation wherein the brake energy storage 16 is charged.

The control of the brake energy storage battery 16 may in one example comprise causing 2220 charging and/or discharging the brake energy storage battery 16. For example, the control of the brake energy storage battery 16 may comprise charging and/or discharging the brake energy storage battery 16 during propulsion of the vehicle 10.

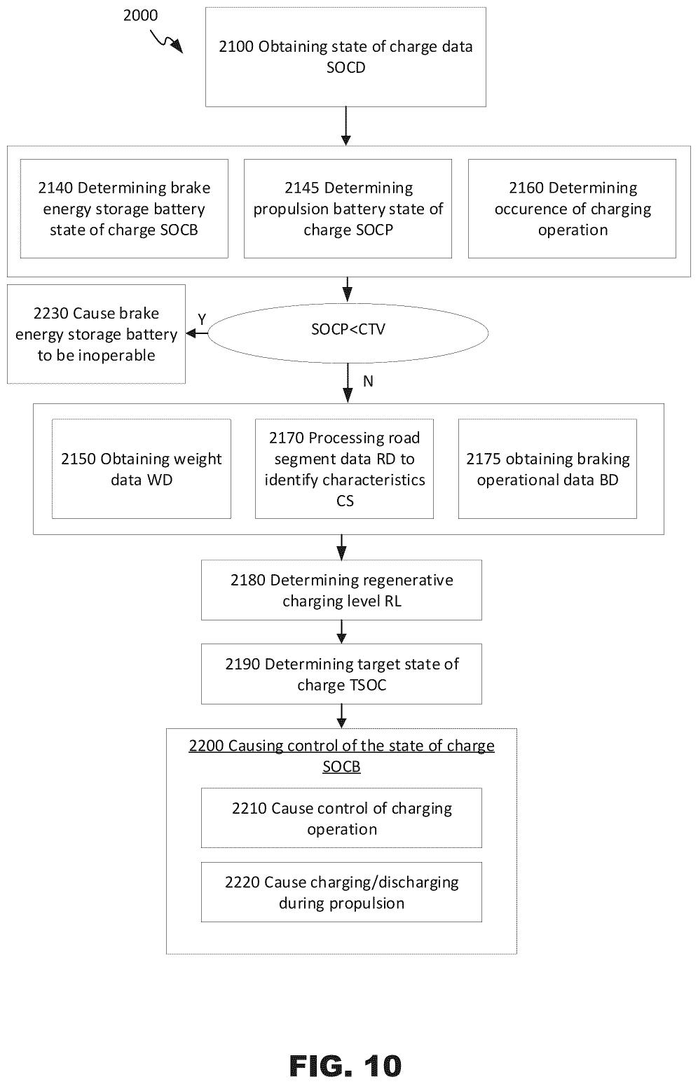

FIG. 10 depicts the method according to another example. In the depicted example, the brake energy storage battery 16 is provided as a battery unit separate from the propulsion battery 14.

According to the depicted example, the state of charge SOCB of the brake energy storage battery 16, the state of charge SOCP of the propulsion battery 14 and/or the occurrence of a charging operation may be determined.

The method may comprise determining 2140, the state of charge SOCB of the brake energy storage battery 16. The state of charge SOCB may be determined based on the state of charge data SOCD.

The method may comprise determining 2145, the state of charge SOCP of the propulsion battery 14. The state of charge SOCP may be determined based on the state of charge data SOCD.

The method may comprise determining 2160, the occurrence of the charging operation. The occurrence of the charging operation based on the state of charge data SOCD.

In the event of the propulsion battery 14 having available capacity for receiving the regenerative energy generated by an upcoming braking of the electrical propulsion motor 12, the propulsion battery 14 may be utilized for the storing of the regenerative energy instead of the brake energy storage battery 16.

The method may comprise determining whether the state of charge SOCP of the propulsion battery 14 is below a capacity threshold value CTV. Responsive to the state of charge SOCP being below the capacity threshold value CTV, the brake energy storage battery 16 may be caused 2230 to be inoperable. Responsive to the state of charge SOCP exceeding the capacity threshold value CTV, control of the state of charge SOCB of the brake energy storage battery 16 may be performed in accordance with steps described with reference to FIG. 8 and/or FIG. 9.

The method 2000 may be expanded and altered to comprise any feature, variant or example presented herein.

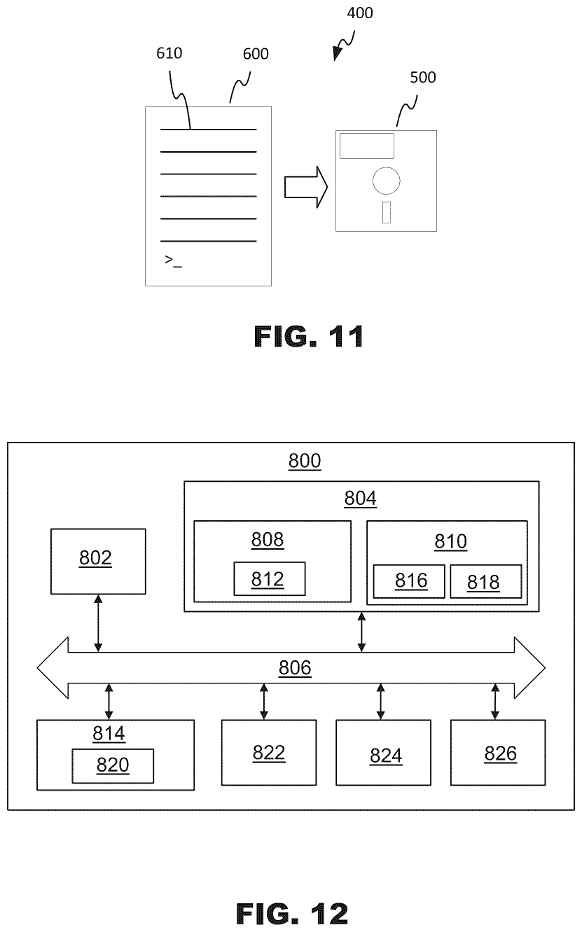

In FIG. 11 a computer program product 400 is shown. The computer program product 400 comprises a computer program 600 and a non-transitory computer readable medium 500. The computer program 600 may be stored on the computer readable medium 500. The computer readable medium 500 is, in FIG. 11, exemplified as a vintage 5,25″ floppy disc, but may be embodied as any suitable non-transitory computer readable medium such as, but not limited to, hard disk drives (HDDs), solid-state drives (SSDs), optical discs (e.g., CD-ROM, DVD-ROM, CD-RW, DVD-RW), USB flash drives, magnetic tapes, memory cards, Read-Only Memories (ROM), network-attached storage (NAS), cloud storage etc.

The computer program 600 comprises instruction 610 e.g. program instruction, software code, that, when executed by processing circuitry cause the processing circuitry to perform the method 2000 introduced with reference to FIG. 8-FIG. 10.

FIG. 11 is a schematic diagram of a computer system 800 for implementing examples disclosed herein. The computer system 800 may be the previously described computer system 700. The computer system 800 is adapted to execute instructions from a computer-readable medium to perform these and/or any of the functions or processing described herein. The computer system 800 may be connected (e.g., networked) to other machines in a LAN, an intranet, an extranet, or the Internet. While only a single device is illustrated, the computer system 800 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 800 may comprise at least one computing device or electronic device capable of including firmware, hardware, and/or executing software instructions to implement the functionality described herein. The computer system 800 may include processing circuitry 802 (e.g., processing circuitry including one or more processor devices or control units), a memory 804, and a system bus 806. The computer system 800 may include at least one computing device having the processing circuitry 802. The system bus 806 provides an interface for system components including, but not limited to, the memory 804 and the processing circuitry 802. The processing circuitry 802 may include any number of hardware components for conducting data or signal processing or for executing computer code stored in memory 804. The processing circuitry 802 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 802 may further include computer executable code that controls operation of the programmable device.

The system bus 806 may be any of several types of bus structures that may further interconnect to a memory bus (with or without a memory controller), a peripheral bus, and/or a local bus using any of a variety of bus architectures. The memory 804 may be one or more devices for storing data and/or computer code for completing or facilitating methods described herein. The memory 804 may include database components, object code components, script components, or other types of information structure for supporting the various activities herein. Any distributed or local memory device may be utilized with the systems and methods of this description. The memory 804 may be communicably connected to the processing circuitry 802 (e.g., via a circuit or any other wired, wireless, or network connection) and may include computer code for executing one or more processes described herein. The memory 804 may include non-volatile memory 808 (e.g., read-only memory (ROM), erasable programmable read-only memory (EPROM), electrically erasable programmable read-only memory (EEPROM), etc.), and volatile memory 810 (e.g., random-access memory (RAM)), or any other medium which can be used to carry or store desired program code in the form of machine-executable instructions or data structures and which can be accessed by a computer or other machine with processing circuitry 802. A basic input/output system (BIOS) 812 may be stored in the non-volatile memory 808 and can include the basic routines that help to transfer information between elements within the computer system 800.

The computer system 800 may further include or be coupled to a non-transitory computer-readable storage medium such as the storage device 814, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 814 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 814 and/or in the volatile memory 810, which may include an operating system 816 and/or one or more program modules 818. All or a portion of the examples disclosed herein may be implemented as a computer program 820 stored on a transitory or non-transitory computer-usable or computer-readable storage medium (e.g., single medium or multiple media), such as the storage device 814, which includes complex programming instructions (e.g., complex computer-readable program code) to cause the processing circuitry 802 to carry out actions described herein. Thus, the computer-readable program code of the computer program 820 can comprise software instructions for implementing the functionality of the examples described herein when executed by the processing circuitry 802. In some examples, the storage device 814 may be a computer program product (e.g., readable storage medium) storing the computer program 820 thereon, where at least a portion of a computer program 820 may be loadable (e.g., into a processor) for implementing the functionality of the examples described herein when executed by the processing circuitry 802. The processing circuitry 802 may serve as a controller or control system for the computer system 800 that is to implement the functionality described herein.

The computer system 800 may include an input device interface 822 configured to receive input and selections to be communicated to the computer system 800 when executing instructions, such as from a keyboard, mouse, touch-sensitive surface, etc. Such input devices may be connected to the processing circuitry 802 through the input device interface 822 coupled to the system bus 806 but can be connected through other interfaces, such as a parallel port, an Institute of Electrical and Electronic Engineers (IEEE) 1394 serial port, a Universal Serial Bus (USB) port, an IR interface, and the like. The computer system 800 may include an output device interface 824 configured to forward output, such as to a display, a video display unit (e.g., a liquid crystal display (LCD) or a cathode ray tube (CRT)). The computer system 800 may include a communications interface 826 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

A system or method according to any of the following examples may be provided.

Example 1: A computer system (700) comprising processing circuitry (702) configured to: obtain state of charge data (SOCD) from a brake energy storage battery (16) of an electrically propelled vehicle (10), said vehicle (10) comprising an electrical motor brake system (19) for braking at least one electrical propulsion motor (12) of said vehicle (10) and charging the brake energy storage battery (16) with regenerative energy obtained from the electrical propulsion motor (12); cause control of a state of charge (SOCB) of the brake energy storage battery (16) based on road segment data (RSD) associated with a road segment ahead of the vehicle (10) and the state of charge data (SOCD).

Example 2: The computer system (700) of example 1, wherein the road segment data (RSD) comprises topography data and/or map data associated with a predicted route and/or a current position of the vehicle (10).

Example 3: The computer system (700) of example 1 or 2, wherein the processing circuitry (702) is further configured to: obtain weight data (WD) associated with a weight of the vehicle (10); and cause control of the state of charge (SOCB) of the brake energy storage battery (16) based on the weight data (WD).

Example 4: The computer system (700) of any of example 1 to 3, the processing circuitry (702) being further configured to: determine a target state of charge (TSOC) of the brake energy storage battery (16) based on the road segment data (RSD); and cause control of the state of charge (SOCB) of the brake energy storage battery (16) based on the target state of charge (TSOC).

Example 5: The computer system (700) of example 4, wherein the processing circuitry (702) is further configured to: determine a regenerative charging level (RL) associated with the charging of the brake energy storage battery (16) estimated to be provided by the electrical motor brake system (19) for the road segment ahead of the vehicle (10); and determine the target state of charge (TSOC) based on the regenerative charging level (RL).

Example 6: The computer system (700) of any of example 1 to 5, wherein the processing circuitry (702) is further configured to process the road segment data (RSD) to identify a downhill slope and cause control of the state of charge (SOCB) of the brake energy storage battery (16) based on characteristics (CS) of the identified downhill slope.

Example 7: The computer system (700) of any of example 1 to 6, wherein the vehicle (10) comprises a propulsion battery (14) configured to power the electric propulsion motor (12).

Example 8: The computer system (700) of example 7, wherein the brake energy storage battery (16) is formed by a battery unit provided separately from the propulsion battery (14).

Example 9: The computer system (700) of example 8, wherein the processing circuitry (702) is configured to cause the brake energy storage battery (16) to be inoperable in response to the state of charge (SOCP) of the propulsion battery (16) being below a capacity threshold value (CTV).

Example 10: The computer system (700) of example 7, wherein the propulsion battery (14) forms the brake energy storage battery (16).

Example 11: The computer system (700) of any of example 1 to 10, wherein the processing circuitry (702) is configured to: determine based on the state of charge data (SOCD) the occurrence of a charging operation wherein the brake energy storage battery (16) is recharged; and responsive to the occurrence of the charging operation, cause control of the charging operation based on the road segment data (RSD).

Example 12: The computer system (700) of any of example 1 to 11, wherein the processing circuitry (702) is configured to: obtain braking operational data (BD) associated with the operation of the electrical motor brake system (19) for the road segment ahead of the vehicle (10); and cause control of the state of charge (SOCB) of the brake energy storage battery (16) based on said braking operational data (BD).

Example 13: An electrically propelled vehicle (10) comprising at least one electrical propulsion motor (12), an electrical motor brake system (19) for braking the at least one electrical propulsion motor (12) and a computer system (700) of any of example 1 to 12.

Example 14: Battery management control system (790) comprising the computer system (700) according to any one of example 1 to 12, wherein the battery management control system (790) is configured to be operatively connected to an electrically propelled vehicle (10).

Example 15: A computer-implemented method (2000) comprising: obtaining (2100), by processing circuitry (702) of a computer system (700), state of charge data (SOCD) from a brake energy storage battery (16) of an electrically propelled vehicle (10), said vehicle (10) comprising an electrical motor brake system (19) for braking at least one electrical propulsion motor (12) of said vehicle (10) and charging the brake energy storage battery (16) with regenerative energy obtained from the electrical motor brake system (19); and causing (2200), by the processing circuitry (702) control of the state of charge (SOCB) of the brake energy storage battery (16) based on road segment data (RSD) associated with a road segment ahead of the vehicle (10) and the state of charge data (SOCD).

Example 16: The method (2000) of example 15, further comprising: obtaining (2150), by the processing circuitry (702), weight data (WD) associated with a weight of the vehicle (10); and causing (2200), by the processing circuitry (702), control of the state of charge (SOCB) of the brake energy storage battery (16) based on the weight data (WD).

Example 17: The method (2000) of example 15 or 16, further comprising: determining (2190), by the processing circuitry (702), a target state of charge (TSOC) of the brake energy storage battery (16) based on the road segment data (RSD); and causing (2200), by the processing circuitry (702), control of the state of charge (SOCB) of the brake energy storage battery (16) based on the target state of charge (TSOC).

Example 18: The method (2000) of any of example 15 to 17, further comprising; determining (2180), by the processing circuitry (702), a regenerative charging level (RL) associated with the charging of the brake energy storage battery (16) estimated to be provided by the electrical motor brake system (19) for the road segment ahead of vehicle (10); and determining (2190), by the processing circuitry (702), the target state of charge (TSOC) based on the regenerative charging level (RL).

Example 19: The method (2000) of any of example 15 to 18, further comprising: processing (2170), by the processing circuitry (702), the road segment data (RD) to identify a downhill slope; and causing (2200) control of the state of charge (SOCB) of the brake energy storage battery (16) based on the characteristics (CS) of the identified downhill slope.

Example 20: The method (2000) of any of example 15 to 19, wherein the brake energy storage battery (16) is a dedicated battery provided separately from a propulsion battery (14) configured to power the electric propulsion motor (12) of the vehicle (10), the method further comprising: causing (2230), by the processing circuitry (702), the brake energy storage battery (16) to be inoperable in response to the state of charge (SOCP) of the propulsion battery (14) being below a capacity threshold value (CTV).

Example 21: The method (2000) of any of example 15 to 20, further comprising: determining (2160), by the processing circuitry (702), the occurrence of a charging operation wherein the brake energy storage battery (16) is recharged; and responsive to the occurrence of the charging operation, causing (2210), by the processing circuitry (702), control of the charging operation based on the road segment data (RD).

Example 22. The method (2000) of any of example 15 to 21, further comprising: obtaining (2175), by the processing circuitry (702), braking operational data (BD) associated with the operation of the electrical motor brake system (19) for the road segment ahead of the vehicle (10); and causing (2200), by the processing circuitry (702) of the state of charge (SOCB) of the brake energy storage battery (16) based on said braking operational data (BD).

Example 23: A computer program product (400) comprising program code (600) for performing, when executed by a processing circuitry (702), the method (2000) of any of examples 15 to 22.

Example 24: A non-transitory computer-readable storage medium (500) comprising instructions, which when executed by a processing circuitry (702), cause the processing circuitry (702) to perform the method (2000) of any of examples 15 to 22.

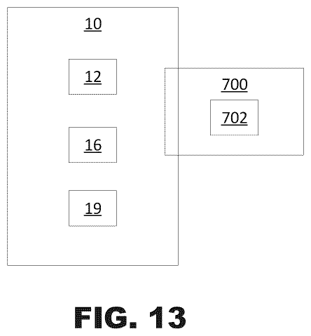

FIG. 13 is another view of FIG. 1 according to an example. The computer system 700 comprises the processing circuitry 702. The processing circuitry 702 is configured to obtain the state of charge data SOCD from the brake energy storage battery 16 of the electrically propelled vehicle 10. The vehicle 10 comprises the electrical motor brake system 19 for braking the at least one electrical propulsion motor 12 of the vehicle 10 and charging the brake energy storage battery 16 with regenerative energy obtained from the electrical propulsion motor 12. The processing circuitry 702 is configured to cause control of the state of charge SOCB of the brake energy storage battery 16 based on the road segment data RSD associated with the road segment ahead of the vehicle 10 and the state of charge data SOCD.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
obtain state of charge data from a brake energy storage battery of an electrically propelled vehicle, said vehicle comprising an electrical motor brake system for braking at least one electrical propulsion motor of said vehicle and charging the brake energy storage battery with regenerative energy obtained from the electrical propulsion motor, and
cause control of a state of charge of the brake energy storage battery based on road segment data associated with a road segment ahead of the vehicle and the state of charge data.

2. The computer system of claim 1, wherein the road segment data comprises topography data and/or map data associated with a predicted route and/or a current position of the vehicle.

3. The computer system of claim 1, wherein the processing circuitry is further configured to:
obtain weight data associated with a weight of the vehicle, and
cause control of the state of charge of the brake energy storage battery based on the weight data.

4. The computer system of claim 1, the processing circuitry being further configured to:
determine a target state of charge of the brake energy storage battery based on the road segment data, and
cause control of the state of charge of the brake energy storage battery based on the target state of charge.

5. The computer system of claim 4, wherein the processing circuitry is further configured to:
determine a regenerative charging level associated with the charging of the brake energy storage battery estimated to be provided by the electrical motor brake system for the road segment ahead of the vehicle;
and determine the target state of charge based on the regenerative charging level.

6. The computer system of claim 1, wherein the processing circuitry is further configured to process the road segment data to identify a downhill slope and cause control of the state of charge of the brake energy storage battery based on characteristics of the identified downhill slope.

7. The computer system of claim 1, wherein the vehicle comprises a propulsion battery configured to power the electric propulsion motor.

8. The computer system of claim 7, wherein the brake energy storage battery is formed by a battery unit provided separately from the propulsion battery.

9. The computer system of claim 8, wherein the processing circuitry is further configured to cause the brake energy storage battery to be inoperable in response to the state of charge of the propulsion battery being below a capacity threshold value.

10. The computer system of claim 7, wherein the propulsion battery forms the brake energy storage battery.

11. The computer system of claim 1, wherein the processing circuitry is configured to:
determine based on the state of charge data the occurrence of a charging operation wherein the brake energy storage battery is recharged, and
responsive to the occurrence of the charging operation, cause control of the charging operation based on the road segment data.

12. The computer system of claim 1, wherein the processing circuitry is configured to:
obtain braking operational data associated with the operation of the electrical motor brake system for the road segment ahead of the vehicle, and
cause control of the state of charge of the brake energy storage battery based on said braking operational data.

13. The computer system claim 1, wherein the road segment data comprises topography data and/or map data associated with a predicted route and/or a current position of the vehicle, and wherein the processing circuitry is further configured to:
obtain weight data associated with a weight of the vehicle,
obtain braking operational data associated with the operation of the electrical motor brake system for the road segment ahead of the vehicle,
determine a target state of charge of the brake energy storage battery based on the road segment data, and
cause control of the state of charge of the brake energy storage battery based on the weight data, the target state of charge and the braking operational data,
and wherein the processing circuitry is further configured to process the road segment data to identify a downhill slope and cause control of the state of charge of the brake energy storage battery based on characteristics of the identified downhill slope.

14. An electrically propelled vehicle comprising at least one electrical propulsion motor, an electrical motor brake system for braking the at least one electrical propulsion motor and a computer system of claim 1.

15. Battery management control system comprising the computer system according to claim 1, wherein the battery management control system is configured to be operatively connected to an electrically propelled vehicle.

16. A computer-implemented method comprising:
obtaining, by processing circuitry of a computer system, state of charge data from a brake energy storage battery of an electrically propelled vehicle, said vehicle comprising an electrical motor brake system for braking at least one electrical propulsion motor of said vehicle and charging the brake energy storage battery with regenerative energy obtained from the electrical motor brake system, and
causing, by the processing circuitry, control of the state of charge of the brake energy storage battery based on road segment data associated with a road segment ahead of the vehicle and the state of charge data.

17. The method of claim 16, further comprising:
obtaining, by the processing circuitry, weight data associated with a weight of the vehicle; and
causing, by the processing circuitry, control of the state of charge of the brake energy storage battery based on the weight data.

18. The method of claim 16, further comprising:
determining, by the processing circuitry, a target state of charge of the brake energy storage battery based on the road segment data; and
causing, by the processing circuitry, control of the state of charge of the brake energy storage battery based on the target state of charge.

19. A computer program product comprising program code for performing, when executed by a processing circuitry, the method of claim 16.

20. A non-transitory computer-readable storage medium comprising instructions, which when executed by a processing circuitry, cause the processing circuitry to perform the method of claim 16.
